(19) United States
(12) Patent Application Publication
(10) Pub. No.: US 2026/0355876 A1
(43) Pub. Date: Nov. 12, 2026

(54) Vane Guide Installation for Tubular Steel Poles

(71) Applicant: QUANTA ASSOCIATES, L.P., Houston, TX (US)

(72) Inventors: Brent Keeler, Pendleton, OR (US); Adam Swarthout, Red Bluff, CA (US)

(21) Appl. No.: 19/649,631

(22) Filed: Apr. 16, 2026

Related U.S. Application Data
(60) Provisional application No. 63/801,325, filed on May 7, 2025.

(51) Int. Cl. B23P 19/10

(52) U.S. Cl. CPC B23P 19/10

(57) ABSTRACT

A first TSP is joined, aligned, and set to a second TSP in a vane guide installation accomplished via helicopter. The vane guide installation has a guide device with a guide bar mounted on the first TSP and a guide plate mounted on the second TSP. The guide plate has dual bar abutment guide arms and a mounting portion, wherein the dual bar abutment guide arms transition into the mounting portion, and wherein the mounting portion is attached to the second TSP. The dual bar abutment guide arms have opposing and complementary bar abutment guide surfaces that define a guide mouth and a guide channel. The guide bar is configured to target and enter the guide mouth and respectively coast-along the opposing and complementary bar abutment guide surfaces for aligning and joining the first TSP to the second TSP via the guide channel.

### STATEMENTS REGARDING FEDERALLY SPONSORED RESEARCH OR DEVELOPMENT

Not Applicable.

### NAMES OF THE PARTIES TO A JOINT RESEARCH AGREEMENT

Not Applicable.

### REFERENCE TO A “SEQUENCE LISTING”, A TABLE, OR A COMPUTER PROGRAM

Not Applicable.

### TECHNICAL FIELD

The disclosure relates to the field of the installation and construction of electrical (or other utility or industry with poles such as communications or cable) infrastructure poles.

### BACKGROUND

Installation of electrical (or other utility or industry with poles such as communications or cable) poles for subsequent installation of lines of cables at remote or difficult to access sites can prove challenging. One tubular steel pole or TSP is commonly designed to slip or wedge fit for joining and setting to another TSP via mass and gravity for installation, setting, and construction of the electrical utility pole. Numerous workers or linemen with tag lines and/or a bucket truck may be needed to properly align and set one TSP to another. However, proper alignment, and setting of the TSP(s), and delivery, can be challenging via workers with tag lines at a remote site. Problems may particularly result when the one TSP needs to be reset to the other TSP because the initial wedge fit must be overcome to separate, and certain of the poles come with cross arms and their integrity must be maintained. Such problems become compounded in the case of installation sites that are remote and/or difficult to access by ground vehicles such as a crane and/or a bucket truck. A helicopter may be used to set one tubular steel poles or TSP to another at a remote or difficult to access installation site, but in such a case workers and tag lines are still necessary. Furthermore, it may be undesirable to have a bucket truck or workers under a helicopter.

### BRIEF SUMMARY

A first TSP is joined, aligned, and set to a second TSP with a vane guide installation via helicopter. Workers in bucket trucks, and works with tag lines are not needed to properly align and set same. The vane guide installation has a guide device mounted on the first TSP and a guide plate mounted on the second TSP. The guide device has a guide bar. The guide plate has dual bar abutment guide arms and a mounting portion, wherein the dual bar abutment guide arms transition into the mounting portion, and wherein the mounting portion is attached to the second TSP. The dual bar abutment guide arms have opposing and complementary bar abutment guide surfaces, wherein the opposing and complementary bar abutment guide surfaces define a guide mouth and a guide channel. The guide bar is configured to target and enter the guide mouth and respectively coast-along the opposing and complementary bar abutment guide surfaces for aligning and joining the first TSP to the second TSP via the guide channel.

The meaning of ‘TSP’ is hereby defined to include tubular steel poles used in the electrical infrastructure industry (or other utility, or industry with poles, such as communications or cable poles, or hybrids of same; or such poles made of other functional materials). Such TSP(s) are not necessarily round or perfectly round-shaped as seen in the figures of the drawings.

The meaning of ‘helicopter’ is hereby defined to include other aerial vehicles capable of lifting, toting, and lowering a heavy load below any such aerial vehicle.

The meaning of ‘coast-along’ as used herein means relative movement along two relative surfaces between two relative devices, wherein the relative surface may abut or come into contact whilst also becoming jostled or separated instantaneously as one relative surface slides, glides or coasts relative to the other bordering surface. Hence, ‘coast-along’ is not limited to constant contact between the bordering relative surfaces.

### BRIEF DESCRIPTION OF DRAWINGS

The embodiments may be better understood, and numerous objects, features, and advantages made apparent to those skilled in the art by referencing the accompanying drawings. These drawings are used to illustrate only typical embodiments of this invention, and are not to be considered limiting of its scope, for the invention may admit to other equally effective embodiments. The figures are not necessarily to scale and certain features and certain views of the figures may be shown exaggerated in scale or in schematic in the interest of clarity and conciseness.

FIG. 1 depicts a schematic elevational view of an exemplary embodiment of an electrical infrastructure installation system utilizing a helicopter lift service for installing TSP(s).

FIG. 2 depicts a perspective view of an exemplary embodiment of a vane guide installation on a joined and aligned TSP(s).

FIG. 3A depicts a perspective view of an exemplary embodiment of a guide device.

FIG. 3B depicts front elevational view of the guide device according to FIG. 3A.

FIG. 3C A depicts side elevational view of the guide device according to FIG. 3A.

FIG. 4A depicts a perspective view of an exemplary embodiment of a guide plate.

FIG. 4B depicts front elevational view of the guide plate according to FIG. 4A.

FIG. 4C A depicts side elevational view of the guide plate according to FIG. 4A.

FIG. 5 depicts a perspective view of an exemplary embodiment of a guide device on a first TSP that is not yet joined to a guide plate on a second TSP.

FIG. 6 depicts an elevational view of an exemplary embodiment of a guide device on a first TSP that is not yet joined to a guide plate on a second TSP.

FIG. 7 depicts an elevational view of an exemplary embodiment of a guide device on a first TSP that is not yet joined to a guide plate on a second TSP rotated somewhat from the view of FIG. 6.

FIG. 8 depicts an exemplary embodiment of a first TSP to be joined to a second TSP in a first position.

FIG. 9 depicts the embodiment of FIG. 8 in a second position.

FIG. 10 depicts the embodiment of FIG. 8 in a third position.

FIG. 11 depicts the embodiment of FIG. 8 in a fourth position.

FIG. 12 depicts the embodiment of FIG. 11 in a fifth position wherein the first TSP is transitioning into joining to the second TSP.

FIG. 13 depicts the embodiment of FIG. 12 in a sixth position wherein the first TSP is transitioning into joining to the second TSP.

FIG. 14 depicts the embodiment of FIG. 13 in a seventh position wherein the first TSP is joining to the second TSP.

FIG. 15 depicts the embodiment of FIG. 14 in an eighth position wherein the first TSP is fully joined, aligned & set to the second TSP.

### DETAILED DESCRIPTION OF EXEMPLARY EMBODIMENTS

The description that follows includes exemplary apparatus, methods, techniques, and instruction sequences that embody techniques of the inventive subject matter. However, it is understood that the described embodiments may be practiced without these specific details.

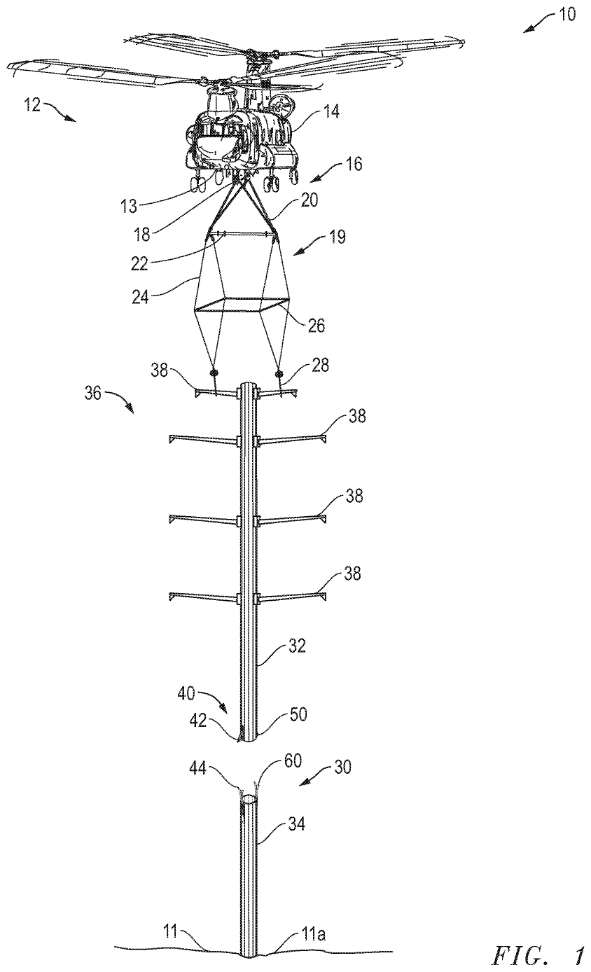

FIG. 1 depicts a schematic view of an electrical (or, other utility or industry with poles, such as communications or cable) pole infrastructure installation system 10 utilizing a helicopter lift service 12, in the exemplary embodiment shown a CH-47 CHINOOK helicopter 14 having external load operations devices/lines or rigging configuration 16 coming below the helicopter 14 in the form of a cargo hooks 18 (e.g., three, at forward, center, & aft) mounted from the belly 13 of the helicopter 14, and an anti-rotational device 19. Anti-rotational device 19 includes anti-rotational device bridles 20, anti-rotational device spreader beam 22, steel wire rope slings 24, a box spreader 26, and remote hooks 28. The helicopter 14 with external load operations device 16 is utilized to lift, carry, lower, and guide TSP(s) 30 for installation of same, and in an exemplary case, a first TSP 32 to a second TSP 34 for installing and constructing one or more electrical utility poles 36 (transmission and/or distribution). The first TSP 32 is commonly designed to slip or wedge fit for joining and setting to the second TSP 34 via mass and gravity for installation, setting, and construction of the electrical utility pole 36. It is desirable to properly align, join, and set the first TSP 32 to the second TSP 34 on the first attempt, without having to reset, because, by way of example, due to the integrity of the TSP 30, alignment of the cross arms 38 and avoidance of having to overcome the initial wedge fit. Such a helicopter lift service 12 may be particularly useful for installation sites 11 that are remote and/or difficult to access via the ground 11a.

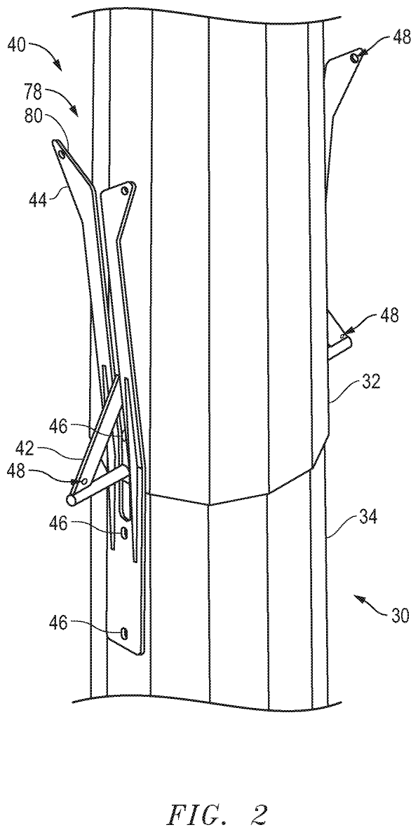

Referring to FIG. 2, an exemplary embodiment of a vane guide installation 40 is shown. The exemplary embodiment of the vane guide installation 40 shown is generally composed of two generally relatively thin angular pieces 42 & 44 (relative to TSP(s) 30) that guide to properly fit together for installation of a first TSP 32 to a second TSP 34. The two relatively thin angular pieces 42 & 44, when mounted (via for example jacking nuts 46), project respectively radially from the first TSP 32 and from the second TSP 34 for guidance used in the process of connecting or joining and setting the first TSP 32 to the second TSP 34. The vane guide installation 40 may define a variety of openings 48 as rigging points for attachment of tag lines (not shown, but known to one of ordinary skill in the art), or the like, if needed. Preferably the vane guide installation 40 is temporary, and in other words can be removed after the first TSP 32 is connected, or aligned, joined, and set to the second TSP 34 as may be desired by the operator(s).

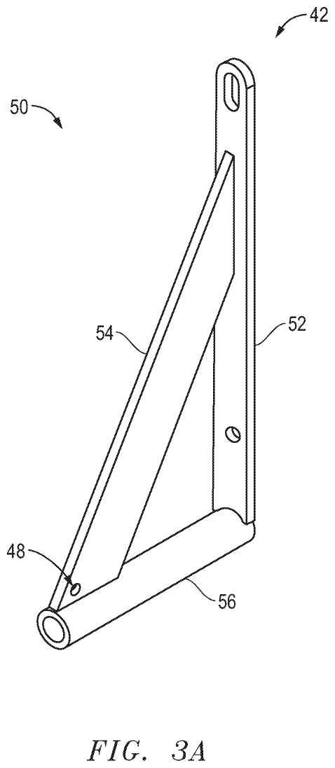

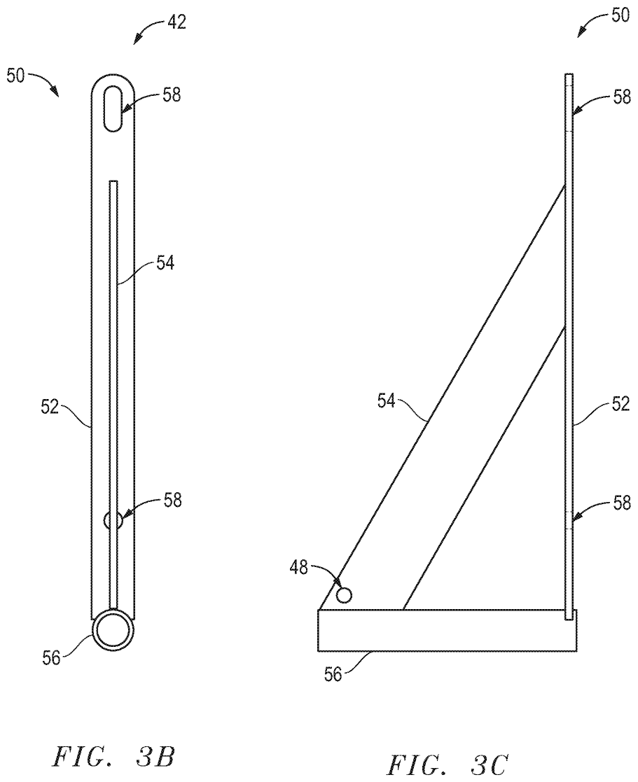

FIGS. 3A, 3B, & 3C show the first generally relatively thin angular piece 42 as a guide device 50. In the exemplary embodiment shown the guide device 50 has a mounting plate 52, a support arm 54, and a guide bar 56. The guide bar 56, by way of example, may be a solid bar, barrel-shaped rod, other shaped bar, or tubing having a 3.0-inch diameter with a 0.25-inch thickness, or about same. The guide bar 56 is fixed to the mounting plate 52 at one end (preferably at a right angle), and the support arm 54 is fixed between the mounting plate 52 and the guide bar 56. The mounting plate 52 has holes or slots 58 (two shown) for attaching, such as by bolting the mounting plate 52 to a first TSP 32. Such bolting or attaching may be made via existing jack nuts 46 located on the first TSP 32.

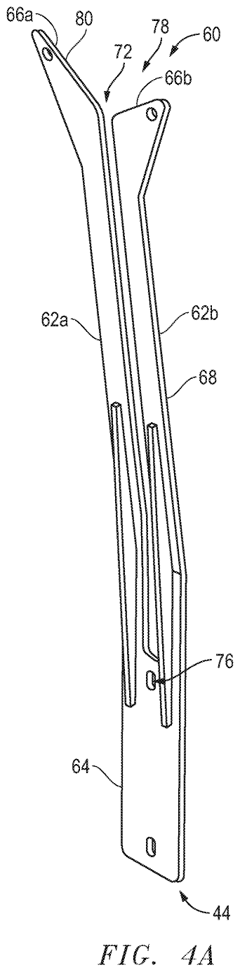

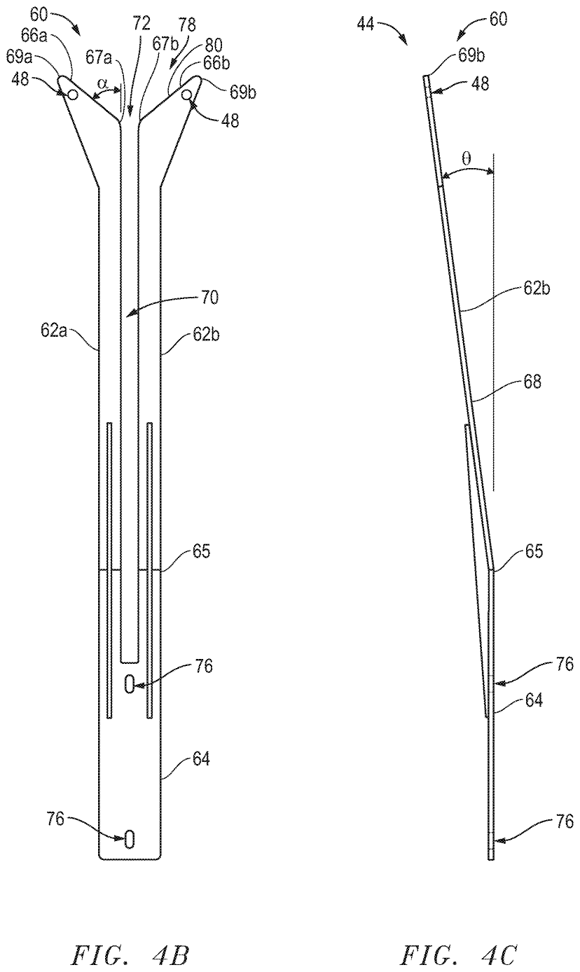

FIGS. 4A, 4B & 4C show the second generally relatively thin angular piece 44 as a guide plate 60. In the exemplary embodiment shown the guide plate 60 has dual bar abutment guide arms 62a & 62b, each or both merging or transitioning into a mounting portion 64. The dual bar abutment guide arms 62a & 62b have respective corresponding opposing and complementary bar abutment guide surfaces 66a & 66b, one each, located at one end of each of the dual bar abutment guide arms 62a & 62b. The mounting portion 64 of the guide plate 60 merges or transitions into an inclined portion 68. The inclined portion 68 extends from one end 65 of the mounting portion 64 to the opposing and complementary bar abutment guide surfaces 66a & 66b. The inclined portion 68 is fixed at an inclined angle Θ to the plane of the mounting portion 64. The dual bar abutment guide arms 62a & 62b define a vertical guide slot or channel 70 (each opposing and complementary bar abutment guide surface 66a & 66b terminates at the entrance 72 to the guide channel 70; or in other words the entrance 72 to the guide channel 70 is located at respective ends 67a & 67b of the opposing and complementary bar abutment guide surfaces 66a & 66b). The defined guide channel 70 may extend into part of the length of the mounting portion 64. The mounting portion 64 has holes or slots 76 (two shown) for attaching, such as by bolting the guide plate 60 to a second TSP 34. Such bolting or attaching may be made via existing jack nuts 46 located on the second TSP 34. The length that the defined channel 70 extends into the mounting portion 64 is limited or bounded by, and must be spaced from, the location of one of the mounting slots 76 in the mounting portion 64.

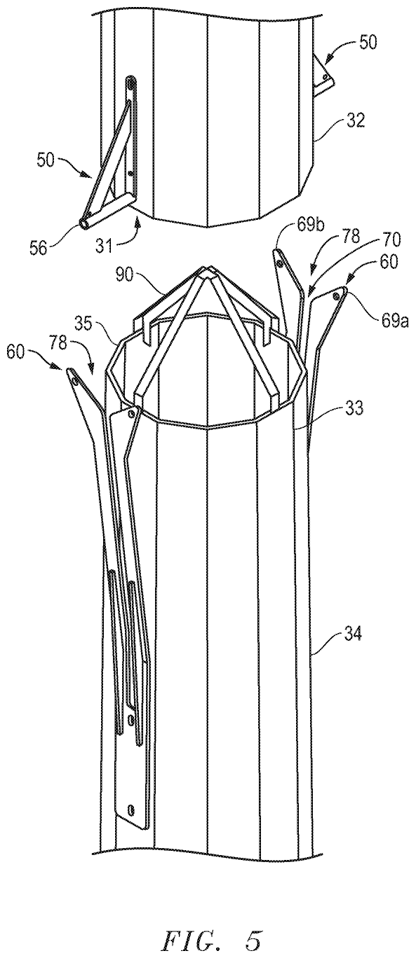

Referring to FIGS. 5-7, the opposing and complementary bar abutment guide surfaces 66a & 66b define a guide mouth 78 that increases in width as an opening starting from the guide channel 70 to the respective tips 69a & 69b of the opposing and complementary bar abutment guide surfaces 66a & 66b. The guide mouth 78 via the opposing and complementary bar abutment guide surfaces 66a & 66b preferably defines a V-shaped guide top-side 80. The guide mouth 78 may define other shapes having a taper, bevel, slope, or generally convex (e.g., hyperbolic-section) or concave (e.g., parabolic-section) top-side. When the guide mouth 78 is a V-shaped guide top-side 80, the opposing and complementary bar abutment guide surfaces 66a & 66b are positioned or oriented at an acute angle α from the longitudinal axis of the guide channel 70.

The width of the guide channel 70 is greater than an outer dimension or diameter of the guide bar 56. In one exemplary embodiment the width of the guide channel 70 is 3.5 inches or about same, and the width of the guide mouth 78 at the respective tips 69a & 69b is 27.82 inches or about same. Hence the guide mouth 78 will taper from a maximum width of about 27.82 inches down to 3.5 inches at the entry 72 to the guide channel 70 (as defined by the length of the opposing and complementary bar abutment guide surfaces 66a & 66b). The overall or full length of the guide channel 70 may vary according to the dimensions and design of respective first TSP 32 and second TSP 34, and such length extends from the entry to the guide channel 70 into part of the length of the mounting portion 64.

In one exemplary embodiment, but not limited to, the inclined angle Θ is 7.5 degrees or about same and the length of the inclined portion 68 is about 96.24 inches. If the inclined angle Θ is too small or shallow, then it will become more challenging for the operator(s) to properly align the first TSP 32 to the second TSP 34 when joined. If the inclined angle Θ is too large, then the length of the guide bar 56 must be increased for enabling the guide bar 56 to abut the respective opposing and complementary bar abutment guide surfaces 66a & 66b for operator joining of the first TSP 32 to the second TSP 34.

Two vane guide installations 40 separated by 180-degrees mounted on and around the circumference or outer boundary of both the first TSP 32 and the second TSP 34 is preferred, but not necessarily required, for proper alignment and installation of the first TSP 32 to the second TSP 34. In other words, a pair of guide devices 50 and a pair or guide plates 60 respectively mounted on opposite sides of each TSP 30 is preferable. This arrangement has the advantage of utilizing the existing jacking nuts 46 which are part of existing off-the-shelf TSP 30 designs. The jacking nuts 46 on existing TSP 30 designs are mounted as pairs on both the first TSP 32 and the second TSP 34 separated by 180-degrees around the TSP 30 for use to evenly, adjust, align, and jack the first TSP 32 relative to the second TSP 34. However, it is to be understood that only one vane guide installation 40 positioned around the entire circumference of the pole, or two, or more, vane guide installations 40 positioned, separated, staggered, or spaced by other than 180-degrees around the circumference or outer boundary of each TSP 30 or arranged in an uneven distribution around the TSP 30 could be implemented and suffice.

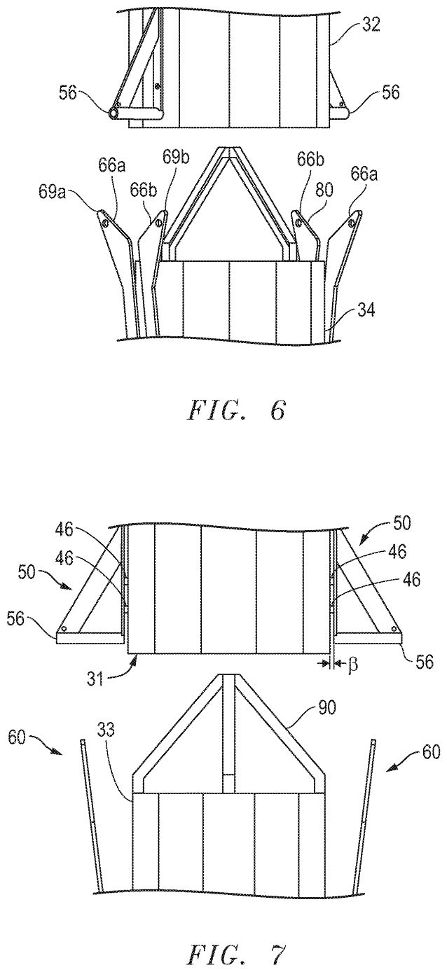

Referring to FIGS. 5 & 7, a tepee, diamond, or cone-shaped guide frame 90 is mounted inside the second TSP 34 and protrudes beyond the end 35 of the second TSP 34. The tepee, diamond, or cone-shaped guide frame 90 assists the operator(s) in aligning the first TSP 32 to the second TSP 34 for proper joining of same. The tepee, diamond, or cone-shaped guide frame 90 could be flipped from mounting in the second TSP 34 to mounting in the first TSP 32. Further referring to FIG. 7, a relatively small gap β may exist between the mounting plate 52 of the guide device 50, and the first TSP 32, created by the jacking bolts 46. The small gap β is relevant in that the radial protrusion of the guide bars 56 must be of sufficient distance to interfere with complementary bar abutment guide surfaces 66a & 66b (i.e., enter the guide mouth 78) at either of the respective tips 69a & 69b, wherein the tips 69a & 69b protrude from the second TSP 34 due to the length of the inclined portion 68 and the inclined portion 68 being fixed at an inclined angle Θ to the plane of the mounting portion 64. The protrusion of the inclined portion 68 including tips 69a & 69b from the second TSP 34 is also critical such that the diameter or dimension of the inner surface 31 of the first TSP 32 can slip over the diameter or dimension of the outer surface 33 of the second TSP 34. A common lubricant, such as dish soap, can be added to aid inner surface 31 of the first TSP 32 to slip over the outer surface 33 of the second TSP 34 and to wedge-fit together to set via mass and gravity.

In the figures shown, the first TSP 32 with guide devices 50 (two shown) attached thereto is upper, and the second TSP 34 with guide plates 60 (two shown) attached thereto is relatively lower. However, it is to be understood that the positions of the guide devices 50 relative to the guide plates 60 could be flipped from upper to lower.

The guide mouth 78 also functions as a target for a helicopter 14 operator to assist in setting the guide bars 56 into the guide mouth 78 and coast-along a respective opposing and complementary bar abutment guide surface 66a or 66b; next setting the first TSP 32 into the second TSP 34; and then slipping the first TSP 32 over the second TSP 34 preferably via the guide bars 56 entering the channels 70 until the second TSP 34 fully wedges into the first TSP 32. By design the first TSP 32 wedge fits to or over the second TSP 34 as gravity takes it down for proper joining of same. A suitable TSP product is commercially available, by way of example only, from Valmont Utility located in Nebraska, US. After the first TSP 32 is properly aligned and joined to the second TSP 34, the vane guide installation 40 can be removed respectively from the first TSP 32 and from the second TSP 34 by releasing via the jacking nuts 46. Hence, the vane guide installation 40 can be temporary.

FIG. 8 depicts a lifted and carried first TSP 32 in a first position 100 being guided and lowered onto a previously installed second TSP 34 by a lone helicopter 14 (see FIG. 1) operator. In the first position 100 there is no contact and proper alignment is potentially established, yet in the FIG. 8 view shown, not yet established between the first TSP 32 and the second TSP 34. The helicopter 14 operator may be targeting the guide mouth 78 with the guide bar 56 (preferably targeting two guide mouths 78 with two respective guide bars 56).

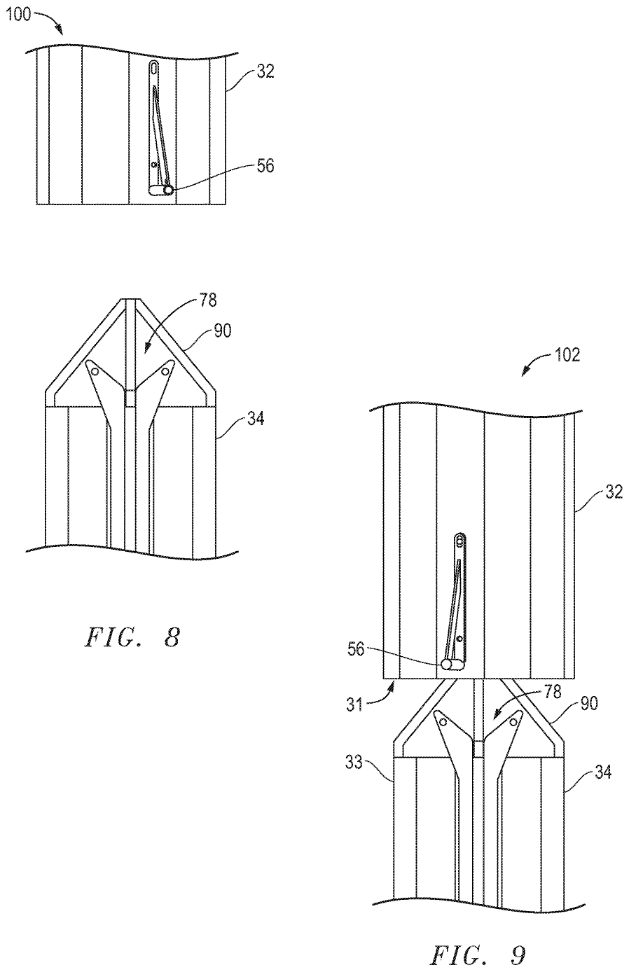

FIG. 9 depicts a carried first TSP 32 in a second position 102 being further guided and lowered onto an installed second TSP 34 by a lone helicopter 14 operator. In the second position 102 the first TSP 32 is at a lower elevation relative to the installed second TSP 34, and the second position 102 preferably occurs subsequent to the first position 100. In the second position 102 there is no contact between the first TSP 32 and the second TSP 34, with the exception that the tepee guide frame 90 may or potentially contacts and may or potentially guides the inner surface 31 of the first TSP 32 toward the outer surface 33 of the second TSP 34. The proper alignment of the guide bar 56 to the guide mouth 78 is preferably beginning to be established between, respectively, the first TSP 32 and the second TSP 34. The helicopter 14 operator is continuing to target the guide mouth 78 with the guide bar 56 (preferably targeting both guide mouths 78 with both respective guide bars 56).

FIG. 10 depicts a carried first TSP 32 in a third position 104 being further guided and lowered onto an installed second TSP 34 by a lone helicopter 14 operator. In the third position 104 relative to the second position 102, the first TSP 32 is at a lower elevation relative to the installed second TSP 34, and the third position 104 preferably occurs subsequent to the second position 102. In the third position 104 there may be contact between the guide bar 56 and the complimentary bar abutment guide surface 66a of the guide mouth 78 via the guide bar 58 targeting and entering the guide mouth 78 and respectively and coasting-along the opposing and complimentary bar abutment guide surface 66a &/or 66b. The tepee guide frame 90 may or potentially contacts and may or potentially guides the inner surface 31 of the first TSP 32 toward the outer surface 33 of the second TSP 34. The proper alignment of the guide bar 56 to the guide mouth 78 has been established between, respectively, the first TSP 32 and the second TSP 34, and the guide bar 56 is being directed toward the guide channel 70. The helicopter 14 operator and gravity are lowering the guide bar 56 into the guide mouth 78 and targeting the guide channel 70 with the guide bar 56 (preferably targeting both guide channels 70 with both respective guide bars 56).

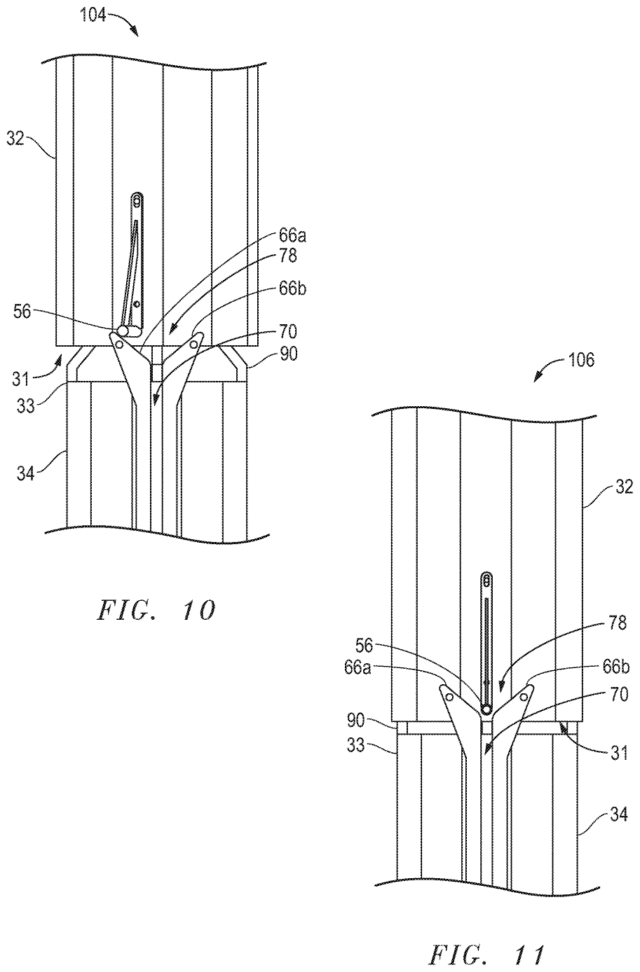

FIG. 11 depicts a carried first TSP 32 in a fourth position 106 being further guided and lowered onto an installed second TSP 34 by a lone helicopter 14 operator. In the fourth position 106 relative to the third position 104, the first TSP 32 is at a lower elevation relative to the installed second TSP 34, and the fourth position 106 preferably occurs subsequent to the third position 104. In the fourth position 106 there may be contact between the guide bar 56 and the guide mouth 78 via the guide bar targeting and entering the guide mouth 78 and respectively coasting-along the opposing and complimentary bar abutment guide surfaces 66a &/or 66b. The tepee guide frame 90 may or potentially contacts and may or potentially guides the inner surface 31 of the first TSP 32 toward the outer surface 33 of the second TSP 34. The proper alignment of the guide bar 56 into the guide channel 70 is beginning to be established between, respectively, the first TSP 32 and the second TSP 34 as the guide bar 56 is being directed into the guide channel 70. The helicopter 14 operator and gravity are further lowering the guide bar 56 into the guide mouth 78 and targeting the guide channel 70 with the guide bar 56 (preferably targeting both guide channels 70 with both respective guide bars 56).

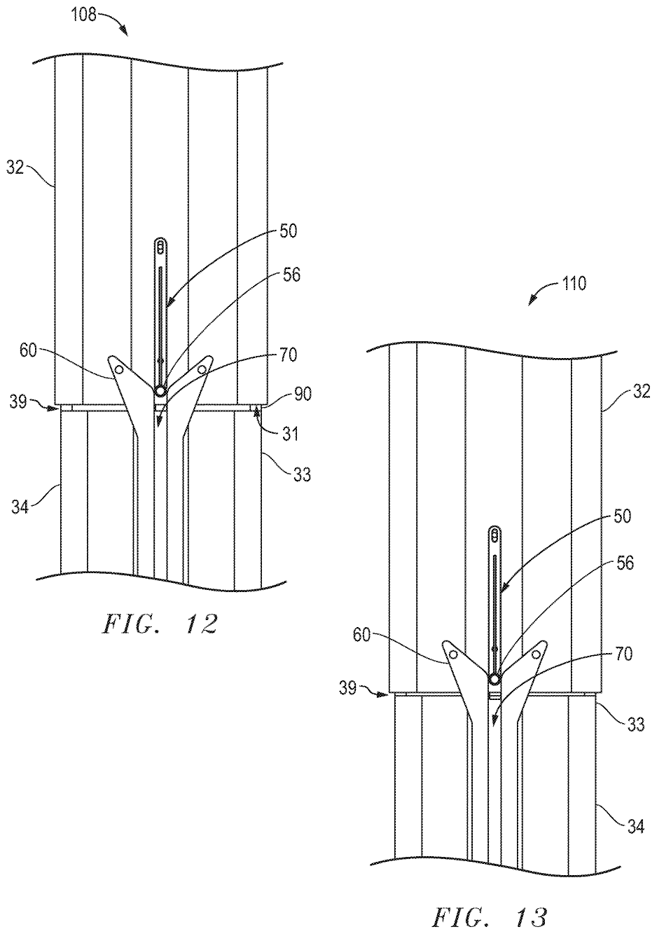

FIG. 12 depicts a carried first TSP 32 in a fifth position 108 being further guided and lowered onto an installed second TSP 34 by a lone helicopter 14 operator. In the fifth position 108 relative to the fourth position 106, the first TSP 32 is at a lower elevation relative to the installed second TSP 34, and the fifth position 108 preferably occurs subsequent to the fourth position 106. In the fifth position 108 the guide bar 56 and guide device 50 is entering the targeted guide channel 70. The tepee guide frame 90 may or potentially contacts and may or potentially guides the inner surface 31 of the first TSP 32 toward the outer surface 33 of the second TSP 34. The proper alignment of the guide bar 56 and the guide device 50 into the guide channel 70 is continuing to be established between, respectively, the first TSP 32 and the second TSP 34. The helicopter 14 operator and gravity are lowering the guide bar 56 into the guide channel 70 (preferably lowering into both guide channels 70 with both respective guide bars 56). In the fifth position 108 preferably the first TSP 32 is not yet joining the second TSP 34 as a gap 39 remains therebetween.

FIG. 13 depicts a carried first TSP 32 in a sixth position 110 being further guided and lowered onto an installed second TSP 34 by a lone helicopter 14 operator. In the sixth position 110 relative to the fifth position 108, the first TSP 32 is at a lower elevation relative to the installed second TSP 34, and the sixth position 110 preferably occurs subsequent to the fifth position 108. In the sixth position 110 the guide bar 56 has fully entered guide channel 70 and the guide device 50 continues to enter the guide channel 70. The tepee guide frame 90 may or potentially contacts and may or potentially guides the inner surface 31 of the first TSP 32 toward the outer surface 33 of the second TSP 34. The proper alignment of the guide bar 56 and the guide device 50 into the guide channel 70 is continuing to be established between, respectively, the first TSP 32 and the second TSP 34. The helicopter 14 operator and gravity are lowering the guide bar 56 and guide device 50 into the guide channel 70 (preferably lowering into both guide channels 70 with both respective guide bars 56). In the sixth position 110 only a very slight or negligible gap 39 remains therebetween the first TSP 32 and the second TSP 34 which are not yet joined.

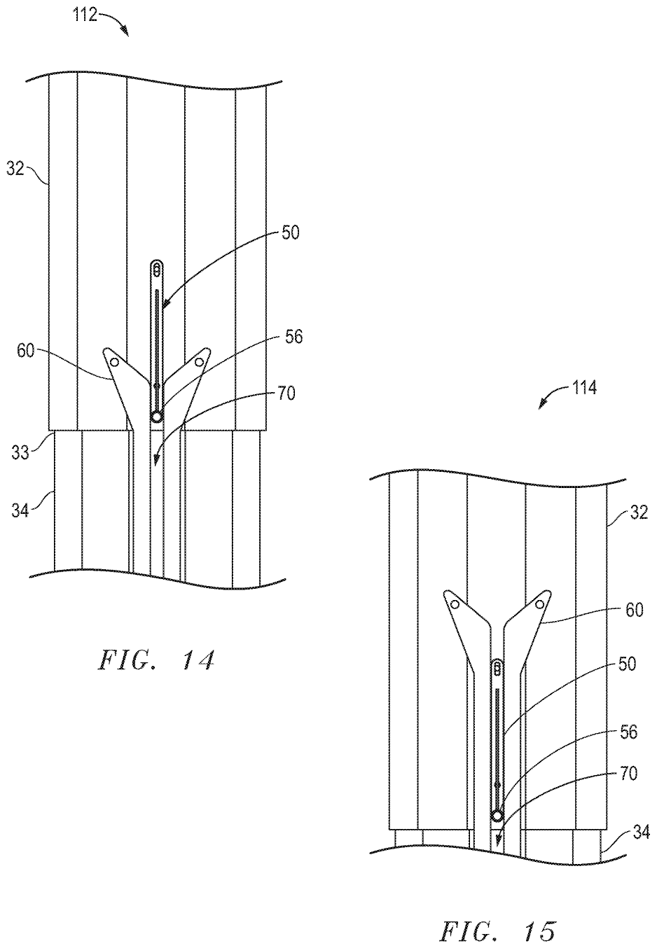

FIG. 14 depicts a carried first TSP 32 in a seventh position 112 being further guided and lowered onto an installed second TSP 34 by a lone helicopter 14 operator. In the seventh position 112 relative to the sixth position 110, the first TSP 32 is at a lower elevation relative to the installed second TSP 34, and the seventh position 112 preferably occurs subsequent to the sixth position 110. In the seventh position 112 the guide bar 56 and the guide device 50 is further dropping down into the guide channel 70. The proper alignment of the guide bar 56 and the guide device 50 into the guide channel 70 is nearly established between, respectively, the first TSP 32 and the second TSP 34. The helicopter 14 operator and gravity are lowering the guide bar 56 and guide device 50 into the guide channel 70 (preferably lowering into both guide channels 70 with both respective guide bars 56). In the seventh position 112 the inner surface 31 of the first TSP 32 and the outer surface 33 of the second TSP 34 are about to initiate or are in the process of joining via relative slipping into a wedge fit.

FIG. 15 depicts a carried first TSP 32 in an eighth position 114 being further guided and lowered onto an installed second TSP 34 by a lone helicopter 14 operator. In the eighth position 114 relative to the seventh position 112, the first TSP 32 is at a lower elevation relative to the installed second TSP 34, and the eighth position 114 preferably occurs subsequent to the seventh position 112. In the eighth position 114 the guide bar 56 and the guide device 50 have dropped down into the guide channel 70 until the inner surface 31 of the first TSP 32 and the outer surface 33 of the second TSP 34 are fully aligned and joined via a mass and gravity wedge fit. The helicopter 14 operator, mass and gravity has fully lowered the guide bar 56 and guide device 50 into the guide channel 70 (preferably fully lowered into both guide channels 70 with both respective guide bars 56) and, hence, the first TSP 32 is fully set and aligned to the second TSP 34. At or immediately after the eighth position 114 the remote hooks 28 can be released from the first TSP 32 and the helicopter 14 can fly away. Adjustments to the alignment and setting of the first TSP 32 to the second TSP 34 can be made via a lineman or worker adjusting the jacking nuts 46.

It is understood that the present disclosure is not limited to the particular applications and embodiments described and illustrated herein, but covers all such variations thereof as come within the scope of the claims. While the embodiments are described with reference to various implementations and exploitations, it will be understood that these embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

The reference numbers in the claims are not intended to be limiting in any way nor to any specific embodiment represented in the drawings, but are included to assist the reader in reviewing the disclosure for purposes of a provisional filing.

1. A vane guide installation apparatus for aligning and joining a first TSP to a second TSP, comprising:
a pair of guide devices, wherein each of the pair of guide devices comprise a mounting plate and a guide bar fixed to the mounting plate, wherein each mounting plate is attached to the first TSP;
a pair of guide plates, wherein each of the pair of guide plates comprises dual bar abutment guide arms and a mounting portion, wherein the dual bar abutment guide arms transition into the mounting portion, and wherein the mounting portion is attached to the second TSP;
wherein the dual bar abutment guide arms have opposing and complimentary bar abutment guide surfaces, and wherein the opposing and complimentary bar abutment guide surfaces define a respective guide mouth; and
whereby the guide bar on each of the pair of guide devices is configured to target and enter the respective guide mouth and respectively and coast-along the opposing and complimentary bar abutment guide surfaces for aligning and joining the first TSP to the second TSP.

2. The vane guide installation apparatus according to claim 1, wherein each respective guide mouth via the opposing and complimentary bar abutment guide surfaces defines a V-shaped guide top-side.

3. The vane guide installation apparatus according to claim 1, wherein the dual bar abutment guide arms define a guide channel beginning at respective ends of the opposing and complimentary bar abutment guide surfaces, and wherein a width of the guide channel is greater than an outer dimension of the guide bar.

4. The vane guide installation apparatus according to claim 1, wherein the pair of guide devices are attached to opposite sides of the first TSP separated by 180-degrees around the first TSP; and wherein the pair of guide plates are attached to opposite sides of the second TSP separated by 180-degrees around the second TSP.

5. The vane guide installation apparatus according to claim 1, wherein the mounting portion of each of the pair of guide plates transitions into an inclined portion, and wherein the inclined portion extends at an inclined angle from one end of the mounting portion to the opposing and complementary bar abutment guide surfaces.

6. The vane guide installation apparatus according to claim 5, wherein the dual bar abutment guide arms define a guide channel beginning at respective ends of the opposing and complimentary bar abutment guide surfaces, and wherein a width of the guide channel is greater than an outer dimension of the guide bar.

7. The vane guide installation apparatus according to claim 6, wherein the pair of guide devices are attached to opposite sides of the first TSP separated by 180-degrees around the first TSP; and wherein the pair of guide plates are attached to opposite sides of the second TSP separated by 180-degrees around the second TSP.

8. A vane guide installation apparatus for aligning and joining a first TSP to a second TSP, comprising:
at least one guide device comprising a mounting plate and a guide bar fixed to the mounting plate, where the mounting plate is attached to the first TSP;
at least one guide plate comprising dual bar abutment guide arms and a mounting portion, wherein the dual bar abutment guide arms transition into the mounting portion, and wherein the mounting portion is attached to the second TSP;
wherein the dual bar abutment guide arms have opposing and complementary bar abutment guide surfaces, and wherein the opposing and complementary bar abutment guide surfaces define a guide mouth; and
whereby the guide bar is configured to target and enter the guide mouth and respectively coast-along the opposing and complementary bar abutment guide surfaces for aligning and joining the first TSP to the second TSP.

9. The vane guide installation apparatus according to claim 8, wherein the guide mouth via the opposing and complementary bar abutment guide surfaces defines a V-shaped guide top-side.

10. The vane guide installation apparatus according to claim 8, wherein the dual bar abutment guide arms define a guide channel beginning at respective ends of the opposing and complementary bar abutment guide surfaces, and wherein a width of the guide channel is greater than an outer dimension of the guide bar.

11. The vane guide installation apparatus according to claim 8, wherein the mounting portion of the guide plate transitions into an inclined portion, and wherein the inclined portion extends at an inclined angle from one end of the mounting portion to the opposing and complementary bar abutment guide surfaces.

12. A method of aligning and installing a first TSP onto a second TSP, comprising the steps of:
with a guide device mounted on the first TSP, and a guide plate mounted on the second TSP defining a guide mouth and a guide channel, targeting the guide mouth and the guide channel on the second TSP with the guide device mounted on the first TSP via a helicopter;
lowering the guide device into the guide mouth via the helicopter and gravity;
aligning the first TSP to the second TSP via the guide device coasting along the guide mouth via the helicopter and gravity;
joining the first TSP to the second TSP via entering the guide channel via the helicopter and gravity;
fully aligning and setting the first TSP into the second TSP by wedge fitting via the helicopter and gravity.

13. The method of aligning and installing the first TSP onto the second TSP according to claim 12, further comprising removing the guide device mounted to the first TSP and removing the guide plate mounted to the second TSP.

14. A method of aligning and installing a first TSP onto a second TSP, comprising the steps of:
with a guide plate mounted on the second TSP defining a guide mouth and a guide channel, guiding, lowering, targeting, and aligning a guide bar mounted on the first TSP via a helicopter and gravity toward the guide mouth mounted on the second TSP at a first position and at a second position;
further guiding, lowering, targeting, and aligning the guide bar to the guide mouth whilst the guide bar is coasting-along an opposing and complimentary bar abutment guide surface located on the guide mouth at a third position via the helicopter and gravity;
further guiding, lowering, targeting, and aligning the guide bar to the guide channel below the guide mouth at a fourth position via the helicopter and gravity;
further guiding, lowering, targeting, and aligning the guide bar to the guide channel and entering the guide channel with the guide bar at a fifth position and at a sixth position via the helicopter and gravity;
further guiding, lowering, targeting, aligning, and entering the guide channel with the guide bar and with a guide device at a seventh position via the helicopter and gravity wherein the first TSP is capable of beginning to wedge fit into the second TSP; and
fully aligning and setting the first TSP into the second TSP by wedge fit at an eighth position via the helicopter and gravity.

15. The method of aligning and installing the first TSP onto the second TSP according to claim 14, further comprising removing the guide device mounted to the first TSP and removing the guide plate mounted to the second TSP.
